(19) United States
(12) Patent Application Publication
(10) Pub. No.: US 2020/0210626 A1
(43) Pub. Date: Jul. 2, 2020

(54) SECURE BRANCH PREDICTOR WITH CONTEXT-SPECIFIC LEARNED INSTRUCTION TARGET ADDRESS ENCRYPTION

(71) Applicant: Samsung Electronics Co., Ltd., Suwon-si (KR)

(72) Inventors: Monika TKACZYK, Austin, TX (US); Brian C. GRAYSON, Austin, TX (US); Mohamad Basem BARAKAT, Cedar Park, TX (US); Eric C. QUINNELL, Austin, TX (US); Bradley G. BURGESS, Austin, TX (US)

(21) Appl. No.: 16/283,725

(22) Filed: Feb. 22, 2019

Related U.S. Application Data
(60) Provisional application No. 62/786,327, filed on Dec. 28, 2018.

(51) Int. Cl. G06F 21/72; H04L 9/08; G06F 9/38

(52) U.S. Cl. CPC G06F 21/72; H04L 9/0869; G06F 7/588; G06F 9/3851; G06F 9/3806

(57) ABSTRACT

According to one general aspect, an apparatus may include a context-specific encryption key circuit configured to generate a key value, wherein the key value is specific to a context of a set of instructions. The apparatus may include a target address prediction circuit configured to provide a target address for a next instruction in the set of instructions. The apparatus may include a target address memory configured to store an encrypted version of the target address, wherein the target address is encrypted using, at least in part, the key value. The apparatus may further include an instruction fetch circuit configured to decrypt the target address using, at least in part, the key value, and retrieve the target address.

### CROSS-REFERENCE TO RELATED APPLICATION

This application claims priority under 35 U.S.C. § 119 to Provisional Patent Application Ser. No. 62/786,327, entitled “SECURE BRANCH PREDICTOR WITH CONTEXT-SPECIFIC LEARNED INSTRUCTION TARGET ADDRESS ENCRYPTION” filed on Dec. 28, 2018. The subject matter of this earlier filed application is hereby incorporated by reference.

### TECHNICAL FIELD

This description relates to computer security, and more specifically to a secure branch predictor with context-specific learned instruction target address encryption.

### BACKGROUND

In 2018, a class of security exploits called Spectre were released to the public. Specifically, Spectre exploits attacked branch predictor targets. The class of attacks subsequently expanded, using various forms of side-channel or timing attacks leak sensitive data to attack processes not privileged to access that data.

Initially the attacks focused on a branch predictor's speculative behavior, where a branch predictor can run ahead of actual program execution and start pulling in cache-lines that it believes will soon be accessed. When the execution portion of the processor catches up, the speculative paths are declared mis-predicted, and the speculative state is flushed. While the software may not see the results of the speculation not-executed in the program, the hardware still retains some state, such as the cachelines brought in speculatively. This speculative state may be forced down a path with a false target injection, and then exploited by an attacker program, using a “timing attack” in a privileged memory space and inferring based on hit latencies which line was speculatively accessed.

Further security holes in the class exposed by branch predictors are an attacker program training predictor targets and return calls in a shared processor to jump to a nefarious target using shared software resources or libraries, then switching the program to a victim thread which uses the common resources to speculatively jump to the poisoned target.

Ultimately, the use of speculation and shared resources on common CPUs expose major security holes in branch predictors, allowing for external programs to infer secrets found speculatively by injecting bad targets, or train to jump to undesired locations.

### SUMMARY

According to one general aspect, an apparatus may include a context-specific encryption key circuit configured to generate a key value, wherein the key value is specific to a context of a set of instructions. The apparatus may include a target address prediction circuit configured to provide a target address for a next instruction in the set of instructions. The apparatus may include a target address memory configured to store an encrypted version of the target address, wherein the target address is encrypted using, at least in part, the key value. The apparatus may further include an instruction fetch circuit configured to decrypt the target address using, at least in part, the key value, and retrieve the target address.

According to another general aspect, a system may include an execution unit circuit to process an instruction associated with a first program. The system may include an instruction fetch circuit configured to retrieve, via branch prediction, the instruction at a target address associated with a first program, and provide the instruction to the execution unit, wherein the instruction fetch circuit is further configured to encrypt the target address such that a malicious second program is unable to read a correct decrypted version of the target address.

According to another general aspect, a method may include, in response to starting to fetch a first stream of instructions, generating a context-specific encryption key value that is substantially unique to and associated with the first stream of instructions.

The method may include determining an instruction address related to the first stream of instructions. The method may include storing an encrypted version of the instruction address within a target address memory, wherein the instruction address is encrypted using, at least in part, the context-specific encryption key value, and such that a second stream of instructions not associated with the context-specific encryption key value is not capable of reading the unencrypted instruction address.

The details of one or more implementations are set forth in the accompanying drawings and the description below. Other features will be apparent from the description and drawings, and from the claims.

A system and/or method for computer security, and more specifically to a secure branch predictor with context-specific learned instruction target address encryption, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a block diagram of an example embodiment of a circuit in accordance with the disclosed subject matter.

FIG. 4 is a schematic block diagram of an information processing system that may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it may be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, and so on may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Likewise, electrical terms, such as “high” “low”, “pull up”, “pull down”, “1”, “0” and the like, may be used herein for ease of description to describe a voltage level or current relative to other voltage levels or to another element(s) or feature(s) as illustrated in the figures. It will be understood that the electrical relative terms are intended to encompass different reference voltages of the device in use or operation in addition to the voltages or currents depicted in the figures. For example, if the device or signals in the figures are inverted or use other reference voltages, currents, or charges, elements described as “high” or “pulled up” would then be “low” or “pulled down” compared to the new reference voltage or current. Thus, the exemplary term “high” may encompass both a relatively low or high voltage or current. The device may be otherwise based upon different electrical frames of reference and the electrical relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

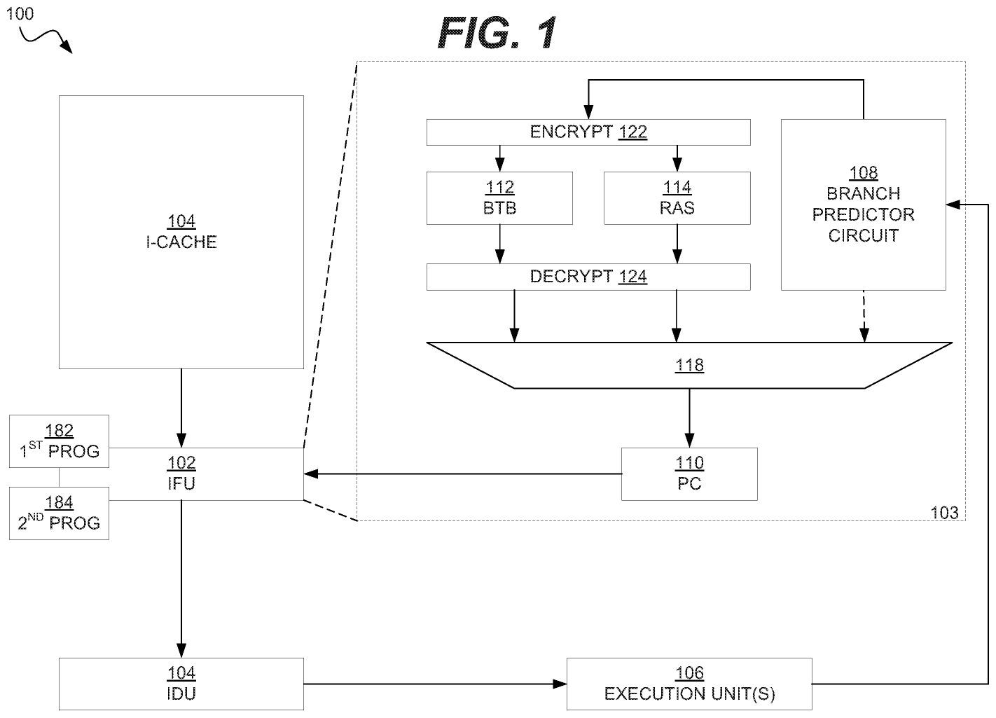

FIG. 1 is a block diagram of an example embodiment of a system 100 in accordance with the disclosed subject matter. In various embodiments, the system 100 may be part of a processor (e.g., central processing unit, graphical processing unit (GPU), system-on-a-chip (SoC), specialized controller processor, etc.), or any pipelined architecture. In various embodiments, the system 100 may be included in a computing device, such as, for example, a laptop, desktop, workstation, personal digital assistant, smartphone, tablet, and other appropriate computers or a virtual machine or virtual computing device thereof.

In various embodiments, the system 100 may illustrate part of the beginning of a pipelined architecture (e.g., the traditional five stage reduced instruction set (RISC) architecture). It is understood that the above is merely one illustrative example to which the disclosed subject matter is not limited.

In such an embodiment, a program, piece of software, or set of instructions 182 may be executed by the system 100. The program 182 may include a variety of instructions. Some of which may flow sequentially. Others of quick may jump between points in the program (e.g., subroutine calls/returns, if/then decisions, etc.).

In the illustrated embodiment, the system 100 may include an instruction cache memory (i-cache) 104. The i-cache 104 may store instructions for processing by the system 100.

In various embodiments, the system 100 may include an instruction fetch unit circuit (IFU) 102. The IFU may be configured to retrieve an instruction (associated with a target address) and begin the process of providing that include to the execution units 106 for processing. In the illustrated embodiment, the IFU 102 may retrieve the instruction pointed to (e.g., by the target address) by the program counter 110.

The IFU 102 may then pass this instruction to the instruction decode unit (IDU) or circuit 104. The IDU 104 may be configured to decode the instruction and route it to the appropriate execution unit 106. In such an embodiment, a number of execution units 106 may exist and process instructions in a variety of ways. For example, execution units 106 may include load/store units, floating-point math units, integer math units, and so on.

As described above, the program 182 may include non-sequential jumps and the system 100 may employ speculative execution to increase efficiency (as opposed to sitting idle while the jump instruction is resolved). To do that, the system 100 may include a branch prediction circuit or system 103. In various embodiments, the branch prediction system 103 may be included as part of the IFU 102. The branch prediction circuit or system 103 may be configured to predict what the next target memory address of the next (predicted) instruction will be.

In the illustrated embodiment, the branch prediction circuit 103 may include a branch predictor circuit 108 that actually does the prediction. The branch prediction circuit 103 may include a branch target buffer (BTB) 112. The BTB 112 may be a content addressable memory that stores predicted or previously encountered target addresses, and is indexed by source addresses. The branch prediction circuit 103 may include a return address stack (RAS) 114. The RAS 114 may be configured to store target addresses to points in the program 182 where subroutines calls were made, or subroutines are expected to return to.

In the illustrated embodiment, the branch predictor circuit 108 may consult the BTB 112 and RAS 114 or its own internal logic and circuitry to produce a predicted target address. The selector 118 (e.g., a multiplexer (MUX)) may then select which ever prediction source is being used, and provide that target address to the program counter 110 or IFU 102. In various embodiments, as the jump instruction is actually resolved by the execution unit 106, the correctness of the prediction may be feedback into the branch predictor circuit 108. It is understood that the above is merely one illustrative example to which the disclosed subject matter is not limited.

As described above, some security exploits (e.g., the Spectre-class exploits) make use of vulnerabilities in the branch prediction circuit 103. In a simplified description, these malicious programs (e.g., second program 184) attempt to access the BTB 112 and RAS 114 to gain target addresses associated with other programs (e.g., first program 182). This may allow the malicious program access to data that it should not have access to. In general, the system 100 should only allow programs 182 & 184 to access target addresses they are respectively associated with. For security reasons, there should be a level of compartmentalization between the programs 182 & 184. As described above, some security exploits (e.g., the Spectre-class exploits) violate that compartmentalization.

In the illustrated embodiment, in order to prevent unauthorized access to a target address, the system 100 may encrypt target addresses. Specifically, the system 100 may encrypt the target addresses as they are stored in one or more memories which stores them (i.e., a target address memory) and represented by the BTB 112 and RAS 114.

In such an embodiment, an encryption circuit 122 may perform the encryption before the target addresses is stored in the BTB 112 and RAS 114 Likewise, a decryption circuit 124 may perform decryption on any target addresses retrieved form the BTB 112 and RAS 114. In various embodiments, other encryption circuits 112 and decryption circuits 114 may be used with other target address memories. In various embodiments, the encryption circuits 112 and decryption circuits 114 may be integrated into the BTB 112, RS 114, or other memories.

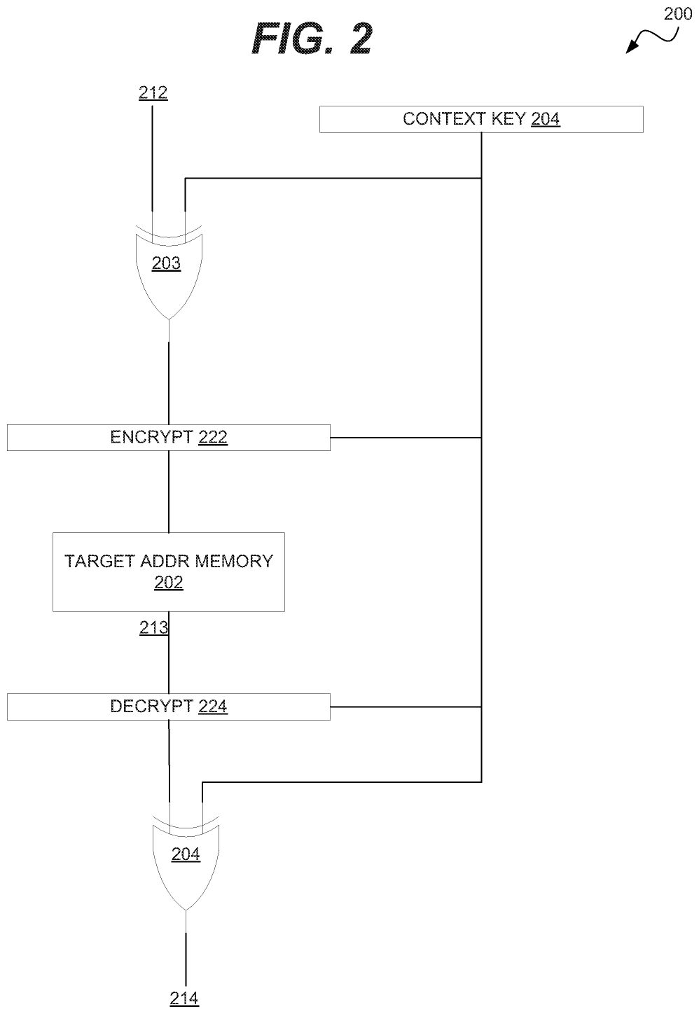

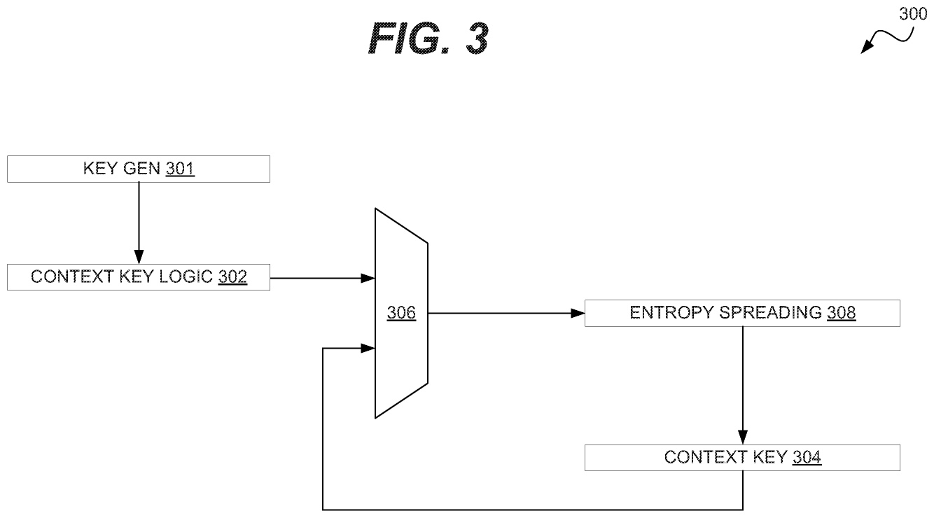

In various embodiments, the target address may be encrypted using a context-specific encryption key (shown in FIGS. 2 and 3). Each context-specific key or has may be associated with and substantially unique to the program 182 that is associated with the target address.

In such an embodiment, if a malicious program 184 were to attempt to read an unauthorized target address (e.g., one associated with the first program 182) from the BTB 112, the decryption circuit 124 would use the malicious program's context-specific key.

Because that key (the malicious program's key) would be incorrect, the value decrypted would not be the target address. The malicious program would only get meaningless gibberish out of the BTB 112/decrypt circuit 124, thus defeating the exploit.

FIG. 2 is a block diagram of an example embodiment of a system 200 in accordance with the disclosed subject matter. In various embodiments, the system 200 may highlight aspects of the encryption employed during a memory access (read and write) to a target address memory 202.

In the illustrated embodiment, the system 200 may include the target address memory 202 (e.g., a BTB, RAS, etc.). The system 200 may include context-specific encryption key 204. The context-specific encryption key 204 may include a register, table, or data structure, wherein a table or other data structure might store a plurality of keys 204 each associated with a different program, set or stream of instructions.

In various embodiments, the context-specific encryption key 204 may be based upon a constant, entropy or random value, and/or contextual values associated with the program. In some embodiments, the contextual values may include, but are not limited to, items like process identifier (ID), kernel ID, security state, hypervisor ID, etc. In various embodiments, the entropy or random value may be provided by software or may be the result of a (substantially) random number generation circuit. In various embodiments, the constant values may be provided by the hardware components (e.g., a serial number, a timer, etc.) and may be provided based upon a context (e.g., the time a program first started) or a secure mode. It is understood that the above are merely a few illustrative examples to which the disclosed subject matter is not limited.

In the illustrated embodiment, the key 204 may be used in the fashion of a stream cipher. In such an embodiment, the encryption may be relatively light-weight and may have minimal impact on the processing timing and power consumption of the overall system 200. In another embodiment, the encryption system may be more involved and heavy-weight, suing more resources and time. It is understood that the above are merely a few illustrative examples to which the disclosed subject matter is not limited.

In the illustrated embodiment, a simple XOR (gates 203 and 204) and/or an offset may secure the target address when reading/writing to/from the target address memory 202. This may avoid adding multi-cycle security rounds to the critical latency of branch predictors.

In the illustrated embodiment, the system 200 may include the XOR gates 203 and 204. The encryption and decryption circuits 222 and 224 may include shifting or substation logic; although, it is understood that the above is merely one illustrative example to which the disclosed subject matter is not limited.

In the illustrated embodiment, when a new target address 212 is to be stored, the address 212 may be XORed with the key 204. The output of the XOR gate 203 may then be shifted, substituted (in part), or masked by the encryption circuit 222. In various embodiments, this may involve the use of the key 204.

Likewise, when a target address is retrieved, the encrypted address 213 may be unshifted, substituted (in part), or masked by the decryption circuit 222. In various embodiments, this may involve the use of the key 204. The address may be XORed with the key 204. The output of the XOR gate 204 may unencrypted or plaintext target address 214 (which may be the same as the address 212, if the same address was both written and read in the example).

In such an embodiment, the system 200 may include barriers to common stream cipher attacks, such as new key 204 calculations for every process or instruction stream, using non-obvious or unexpected constants to scramble plaintext attacks, and/or entropy spreaders on the key 204.

In one embodiment, by scrambling or encrypting a stored target address, both the cases of speculative execution and shared resource attacks from cross training to protected addresses may be thwarted, as only the process which created or is associated with the target address will have the correct key 204 to unscramble the target addresses. Any attacker program that injects false target addresses or trains a program to jump to an undesired location will incorrectly decode or decrypt the target address and send the processor to an unknown location.

In such an embodiment, any branch predictor training (e.g., shared library training) may only react to an incorrectly decrypted target address by mis-predicting and re-learning the target address in a new context once. In various embodiments, the branch predictor bias, history, and/or training may not be lost in a context switch, as those may be unencrypted internal values or metadata associated with a target address. In such an embodiment, the encryption of the target addresses may have almost negligible performance loss, while making an attack significantly more expensive.

FIG. 3 is a block diagram of an example embodiment of a circuit 300 in accordance with the disclosed subject matter. In various embodiments, the system 300 may illustrate one embodiment of the creation of a context-specific has or key 304. It is understood that the above is merely one illustrative example to which the disclosed subject matter is not limited.

In the illustrated embodiment, the system 300 may include a context key 304, as described above. The system 300 may also include a logic or circuity 302 to create an initial version of the context key. In such an embodiment, the initial version may be copied from a key generator 301, which may include a register that stores an ID (e.g., a virtual machine ID, process ID, etc.) or a hardware specific value (e.g., a serial number, a timer). The system 300 may also include an entropy spreading circuit 308 and a selector circuit 306 (e.g., a multiplexer). It is understood that the above are merely a few illustrative examples to which the disclosed subject matter is not limited.

In such an embodiment, the initial context key 304 may be calculated (by circuit 302) from one or more inputs or entropy sources (key generator 301). These including but not limited to hardware or software defined entropy sources, process ids, virtual machine ids, privilege levels, etc.

In the illustrated embodiment, the context has 304 may be subjected to one or many iterative rounds of entropy spreading (e.g., entropy spreader circuit 308). In a specific embodiment, this may include a deterministic non-linear shifting and XORing of bits to average per-bit randomness based on a fixed set of inputs. In general processor context changes are relatively non-optimized and tedious to store and migrate machine state, so multiple levels of constant XOR hashing or encryption and iterative entropy spreading may have a low performance impact.

As described above, when the context key 304 has been selected and undergone a sufficient number of entropy spreading iterations, the key 304 may be used much like a stream cipher to XOR with the target addresses (e.g., indirect branch or return targets) being stored in the BTB or RAS. In various embodiments, a simple substitution cipher or bit shift may be employed to further obfuscate the actual stored address. When the branch predictor is trained and ready to predict jump targets from these structures, the program's context key 304 may be suitable and invertible to translate out the correct prediction target.

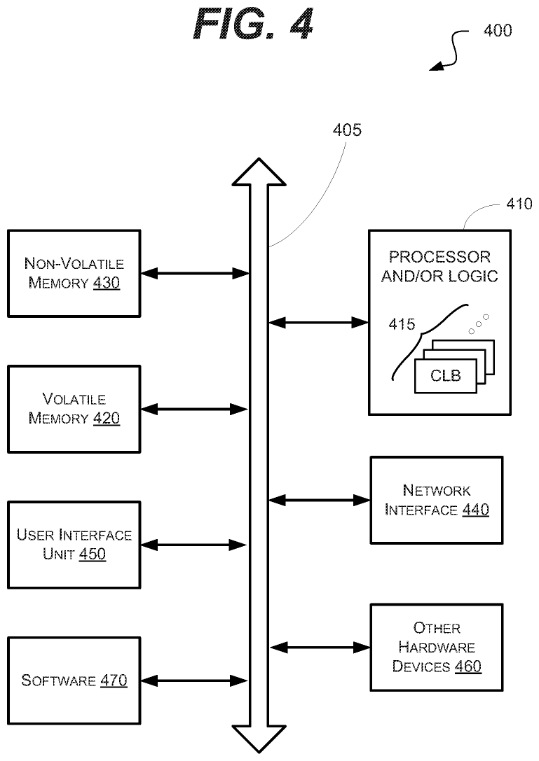

FIG. 4 is a schematic block diagram of an information processing system 400, which may include semiconductor devices formed according to principles of the disclosed subject matter.

Referring to FIG. 4, an information processing system 400 may include one or more of devices constructed according to the principles of the disclosed subject matter. In another embodiment, the information processing system 400 may employ or execute one or more techniques according to the principles of the disclosed subject matter.

In various embodiments, the information processing system 400 may include a computing device, such as, for example, a laptop, desktop, workstation, server, blade server, personal digital assistant, smartphone, tablet, and other appropriate computers or a virtual machine or virtual computing device thereof. In various embodiments, the information processing system 400 may be used by a user (not shown).

The information processing system 400 according to the disclosed subject matter may further include a central processing unit (CPU), logic, or processor 410. In some embodiments, the processor 410 may include one or more functional unit blocks (FUBs) or combinational logic blocks (CLBs) 415. In such an embodiment, a combinational logic block may include various Boolean logic operations (e.g., NAND, NOR, NOT, XOR), stabilizing logic devices (e.g., flip-flops, latches), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 400 according to the disclosed subject matter may further include a volatile memory 420 (e.g., a Random Access Memory (RAM)). The information processing system 400 according to the disclosed subject matter may further include a non-volatile memory 430 (e.g., a hard drive, an optical memory, a NAND or Flash memory). In some embodiments, either the volatile memory 420, the non-volatile memory 430, or a combination or portions thereof may be referred to as a “storage medium”. In various embodiments, the volatile memory 420 and/or the non-volatile memory 430 may be configured to store data in a semi-permanent or substantially permanent form.

In various embodiments, the information processing system 400 may include one or more network interfaces 440 configured to allow the information processing system 400 to be part of and communicate via a communications network. Examples of a Wi-Fi protocol may include, but are not limited to, Institute of Electrical and Electronics Engineers (IEEE) 802.11g, IEEE 802.11n. Examples of a cellular protocol may include, but are not limited to: IEEE 802.16m (a.k.a. Wireless-MAN (Metropolitan Area Network) Advanced, Long Term Evolution (LTE) Advanced, Enhanced Data rates for GSM (Global System for Mobile Communications) Evolution (EDGE), Evolved High-Speed Packet Access (HSPA+). Examples of a wired protocol may include, but are not limited to, IEEE 802.3 (a.k.a. Ethernet), Fibre Channel, Power Line communication (e.g., HomePlug, IEEE 1901). It is understood that the above are merely a few illustrative examples to which the disclosed subject matter is not limited.

The information processing system 400 according to the disclosed subject matter may further include a user interface unit 450 (e.g., a display adapter, a haptic interface, a human interface device). In various embodiments, this user interface unit 450 may be configured to either receive input from a user and/or provide output to a user. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

In various embodiments, the information processing system 400 may include one or more other devices or hardware components 460 (e.g., a display or monitor, a keyboard, a mouse, a camera, a fingerprint reader, a video processor). It is understood that the above are merely a few illustrative examples to which the disclosed subject matter is not limited.

The information processing system 400 according to the disclosed subject matter may further include one or more system buses 405. In such an embodiment, the system bus 405 may be configured to communicatively couple the processor 410, the volatile memory 420, the non-volatile memory 430, the network interface 440, the user interface unit 450, and one or more hardware components 460. Data processed by the processor 410 or data inputted from outside of the non-volatile memory 430 may be stored in either the non-volatile memory 430 or the volatile memory 420.

In various embodiments, the information processing system 400 may include or execute one or more software components 470. In some embodiments, the software components 470 may include an operating system (OS) and/or an application. In some embodiments, the OS may be configured to provide one or more services to an application and manage or act as an intermediary between the application and the various hardware components (e.g., the processor 410, a network interface 440) of the information processing system 400. In such an embodiment, the information processing system 400 may include one or more native applications, which may be installed locally (e.g., within the non-volatile memory 430) and configured to be executed directly by the processor 410 and directly interact with the OS. In such an embodiment, the native applications may include pre-compiled machine executable code. In some embodiments, the native applications may include a script interpreter (e.g., C shell (csh), AppleScript, AutoHotkey) or a virtual execution machine (VM) (e.g., the Java Virtual Machine, the Microsoft Common Language Runtime) that are configured to translate source or object code into executable code which is then executed by the processor 410.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting but are illustrative only. Thus, the scope of the disclosed concepts is to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. An apparatus comprising:
a context-specific encryption key circuit configured to generate a key value, wherein the key value is specific to a context of a set of instructions;
a target address prediction circuit configured to provide a target address for a next instruction in the set of instructions;
a target address memory configured to store an encrypted version of the target address, wherein the target address is encrypted using, at least in part, the key value; and
an instruction fetch circuit configured to decrypt the target address using, at least in part, the key value, and retrieve the target address.

2. The apparatus of claim 1, wherein the target address memory includes a branch target buffer.

3. The apparatus of claim 1, wherein the context-specific encryption key circuit comprises:
a random number generator circuit to generate a substantially random number;
an identifier associated with the set of instructions; and
an entropy spreading circuit configured to combine the random number with the identifier to create the key value.

4. The apparatus of claim 3, wherein the identifier includes value selected from a set including: a process identifier, a virtual machine identifier, a privilege level, kernel identifier, and a security state value.

5. The apparatus of claim 3, wherein the entropy spreading circuit is configured to perform multiple iterations of combining to create the key value, wherein each iteration includes a prior iteration's output as a current iteration's input.

6. The apparatus of claim 1, wherein the target address prediction circuit is configured to:
encrypt the target address using, at least in part, a stream cipher and the key value, and
store the encrypted version of the target address within the target address memory.

7. The apparatus of claim 1, wherein the target address is encrypted such that, if an incorrect key value is employed in an attempt to decrypt the encrypted target address, a false target address is recovered.

8. The system of claim 1, wherein the target address prediction circuit is configured to generate branch bias information that is associated with the target address, and wherein the branch bias information is not encrypted.

9. A system comprising:
an execution unit circuit to process an instruction associated with a first program; and
an instruction fetch circuit configured to retrieve, via branch prediction, the instruction at a target address associated with a first program, and provide the instruction to the execution unit, wherein the instruction fetch circuit is further configured to encrypt the target address such that a malicious second program is unable to read a correct decrypted version of the target address.

10. The system of claim 9, wherein instruction fetch circuit is configured to prevent the second program from correctly reading the target address if the second program attempts to exploit a Spectre-class speculative execution flaw.

11. The system of claim 9, wherein the instruction fetch circuit comprises:
a context-specific encryption key circuit configured to generate a key value, wherein the key value is specific to a context of a set of instructions, and
a target address memory configured to store an encrypted version of the target address, wherein the target address is encrypted using, at least in part, the key value; and
wherein the instruction fetch circuit is configured to decrypt the target address using, at least in part, the key value.

12. The system of claim 9, wherein the target address memory includes a return address stack.

13. The system of claim 9, wherein the context-specific encryption key circuit comprises:
a random number generator circuit to generate a substantially random number;
an identifier associated with the set of instructions; and
an entropy spreading circuit configured to combine the random number with the identifier to create the key value.

14. The system of claim 13, wherein the identifier includes value selected from a set including: a process identifier, a virtual machine identifier, a privilege level, kernel identifier, and a security state value.

15. The system of claim 13, wherein the entropy spreading circuit is configured to perform multiple iterations of combining to create the key value, wherein each iteration includes a prior iteration's output as a current iteration's input.

16. The system of claim 13, wherein the instruction fetch circuit comprises a target address prediction circuit configured to:
encrypt the target address using, at least in part, a stream cipher and the key value, and
store the encrypted version of the target address within the target address memory.

17. A method comprising:
in response to starting to fetch a first stream of instructions, generating a context-specific encryption key value that is substantially unique to and associated with the first stream of instructions;
determining an instruction address related to the first stream of instructions; and
storing an encrypted version of the instruction address within a target address memory, wherein the instruction address is encrypted using, at least in part, the context-specific encryption key value, and such that a second stream of instructions not associated with the context-specific encryption key value is not capable of reading the unencrypted instruction address.

18. The method of claim 17, further comprising:
reading the instruction address within a target address memory, wherein reading comprises decrypting the encrypted version of the instruction address using, at least in part, the context-specific encryption key value.

19. The method of claim 17, wherein the second stream of instructions is configured to exploit a Spectre-class speculative execution flaw.

20. The method of claim 17, wherein generating a context-specific encryption key value includes utilizing and identifier associated with the first stream of instructions, wherein the identifier includes value selected from a set including: a process identifier, a virtual machine identifier, a privilege level, kernel identifier, and a security state value.
